(19) United States
(12) Patent Application Publication
(10) Pub. No.: US 2015/0179316 A1
(43) Pub. Date: Jun. 25, 2015

(54) Methods of forming nitrides at low substrate temperatures

(71) Applicant: Intermolecular Inc., San Jose, CA (US)

(72) Inventors: Chien-Lan Hsueh, Campbell, CA (US); Randall J. Higuchi, San Jose, CA (US)

(73) Assignee: Intermolecular Inc., San Jose, CA (US)

(21) Appl. No.: 14/139,260

(22) Filed: Dec. 23, 2013

(51) Int. Cl. H01C 17/08

(52) U.S. Cl. CPC H01C 17/08

(57) ABSTRACT

Provided are methods of forming nitrides at low substrate temperatures, such as less than 500° C. or even less than 400° C. The nitrides can be formed using atomic layer deposition (ALD), chemical vapor deposition (CVD), and other like techniques. The low substrate temperatures allow using various temperature sensitive precursors, such as Tetrakis(DiMethylAmino)Hafnium (i.e., TDMAHf) or TertiaryButylimido-Tris(DiEthylamino)Tantalum (i.e., TBTDET), to form nitrides of components provided by these precursors. Furthermore, the low temperatures preserve other structures present on the substrate prior to forming the nitride layers. Nitrogen-containing precursors with low dissociation energy are used in these methods. Some examples of such nitrogen-containing precursors include hydrazine (N₂H₄), diazene (N₂H₂), triazene (N₃H₃), triazane (N₃H₅), alkyl-substituted variations thereof, and salts thereof. Also provided are methods of forming oxy-nitrides using low substrate temperatures. Nitride and oxy-nitride layers formed using these methods may be used as embedded resistors in resistive switching memory (ReRAM) cells and other like applications.

### BACKGROUND

Nonvolatile memory is computer memory capable of retaining stored information even when unpowered. Non-volatile memory is typically used for secondary storage or long-term persistent storage and may be used in addition to volatile memory, which loses the stored information when unpowered. Nonvolatile memory can be permanently integrated into computer systems (e.g., solid state hard drives) or can take the form of removable and easily transportable memory cards (e.g., USB flash drives). Nonvolatile memory is becoming more popular because of its small size/high density, low power consumption, fast read and write rates, retention, and other characteristics.

Flash memory is a common type of nonvolatile memory because of its high density and low fabrication costs. Flash memory is a transistor-based memory device that uses multiple gates per transistor and quantum tunneling for storing the information on its memory device. Flash memory uses a block-access architecture that can result in long access, erase, and write times. Flash memory also suffers from low endurance, high power consumption, and scaling limitations.

The constantly increasing speed of electronic devices and storage demand drive new requirements for nonvolatile memory. For example, nonvolatile memory is expected to replace hard drives in many new computer systems. However, transistor-based flash memory is often inadequate to meet the requirements for nonvolatile memory. New types of memory, such as resistive random access memory (ReRAM), are being developed to meet these demands and requirements.

Various nitrides have been considered for various components of ReRAM cells, in particular for embedded resistors because of their stable performance and tunable resistance characteristics. However, deposition of nitrides usually requires elevated temperatures that may be damaging to other cell or circuit components. Furthermore, the high temperature requirement limits the selection of the precursors that may be reacted with nitrogen containing precursors during deposition of nitrides.

### SUMMARY

Provided are methods of forming nitrides at low substrate temperatures, such as less than 500° C. or even less than 400° C. The nitrides can be formed using atomic layer deposition (ALD), chemical vapor deposition (CVD), and other like techniques. The low substrate temperatures allow using various temperature sensitive precursors, such as Tetrakis(DiMethylAmino)Hafnium (i.e., TDMAHf) or TertiaryButylimido-Tris(DiEthylamino)Tantalum (i.e., TBTDET), to form nitrides of components provided by these precursors. Furthermore, the low temperatures preserve other structures present on the substrate prior to forming the nitride layers. Nitrogen-containing precursors with low dissociation energy are used in these methods. Some examples of such nitrogen-containing precursors include hydrazine (N₂H₄), diazene (N₂H₂), triazene (N₃H₃), triazane (N₃H₅), alkyl-substituted variations thereof, and salts thereof. Also provided are methods of forming oxy-nitrides using low substrate temperatures. Nitride and oxy-nitride layers formed using these methods may be used as embedded resistors in resistive switching memory (ReRAM) cells and other like applications.

In some embodiments, a method involves providing a substrate having a surface into a chamber. The substrate may be at a temperature of less than 500° C. The method proceeds with introducing a nitrogen containing precursor and a chemical element containing precursor into the chamber. The nitrogen containing precursor includes nitrogen. The chemical element containing precursor comprises a chemical element that is not nitrogen. The method then proceeds with forming the layer on the surface of the substrate. The layer includes the chemical element and nitrogen. In some embodiments, the substrate has a temperature of less than 400° C. or even less than less than 350° C. Even at these low temperatures, the nitrogen containing precursor reacts with the chemical containing precursor. The nitrogen containing precursor may include one of hydrazine (N₂H₄), diazene (N₂H₂), triazene (N₃H₃), triazane (N₃H₅), alkyl-substituted variations thereof, or salts thereof. Specifically, the nitrogen containing precursor may include hydrazine (N₂H₄) or triazane (N₃H₅). The chemical element of the chemical element containing precursor may be one of tantalum, silicon, hafnium, or zirconium. In some embodiments, the chemical element includes a transition metal. In some embodiments, the layer also comprises silicon in addition to nitrogen and the chemical element, such as tantalum, hafnium, or zirconium. For example, the layer may include tantalum silicon nitride, hafnium silicon nitride, or zirconium silicon nitride. Furthermore, the layer further may include oxygen in addition to nitrogen and the chemical element. In some embodiments, both oxygen and nitrogen may be present in addition to nitrogen and the chemical element.

The chemical element containing precursor may be one of Tetrakis(DiMethylAmino)Hafnium (i.e., TDMAHf) or TertiaryButylimido-Tris(DiEthylamino)Tantalum (i.e., TBTDET). Forming the layer may include using atomic layer deposition (ALD) or chemical layer deposition (CVD). In some embodiments, forming the layer involves exposing the surface of the substrate to ultraviolet (UV) radiation. Furthermore, forming the layer may be performed without using plasma.

In some embodiments, the layer that includes nitrogen and the chemical element is an embedded resistor of a ReRAM cell. Specifically, the layer may include metal nitride films (e.g., TaN, HfN, TiN, ZrN, TaN), metal silicon nitride films (e.g., TaSiN, HfSiN, TiSiN, ZrSiN, TaSiN), or oxynitride counterpart thereof (e.g., TaON, HfON, TiON, ZrON, TaSiON, TaSiON, HfSiON, TiSiON, ZrSiON, TaSiON). In these embodiments, the method may involve forming a resistive switching layer on the substrate.

In some embodiments, a method involves providing a substrate having a surface into a chamber. The substrate may be at a temperature of less than 500° C. The method may proceed with introducing Tetrakis(DiMethylAmino)Hafnium into the chamber and forming a monolayer of Tetrakis(DiMethylAmino)Hafnium on the surface. The method may proceed with introducing hydrazine into the chamber and forming a layer including hafnium and nitride on the surface. The layer is formed when hydrazine reacts with Tetrakis(DiMethylAmino)Hafnium in the monolayer.

These and other embodiments are described further below with reference to the figures.

### BRIEF DESCRIPTION OF THE DRAWINGS

To facilitate understanding, the same reference numerals have been used, where possible, to designate common components presented in the figures. The drawings are not to scale and the relative dimensions of various elements in the drawings are depicted schematically and not necessarily to scale. Various embodiments can readily be understood by considering the following detailed description in conjunction with the accompanying drawings, in which:

FIGS. 1A and 1B illustrate schematic representations of a ReRAM cell in its high resistive state (HRS) and low resistive state (LRS), in accordance with some embodiments.

FIG. 2 illustrates a plot of a current passing through a ReRAM cell as a function of a voltage applied to the ReRAM cell, in accordance with some embodiments.

FIG. 3 illustrates a process flowchart corresponding to a method of forming a layer on the surface of a substrate using a nitrogen containing precursor, in accordance with some embodiments.

FIG. 4 illustrates a schematic representation of a ReRAM cell including an embedded resistor, in accordance with some embodiments.

FIG. 5 illustrates a schematic representation of an atomic layer deposition (ALD) apparatus for executing a method of forming a layer on the surface of a substrate using a nitrogen containing precursor, in accordance with some embodiments.

### DETAILED DESCRIPTION OF EXAMPLE EMBODIMENTS

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

### Introduction

Various nitride containing materials, such as metal nitrides, metal silicon nitrides, metal oxy-nitrides and metal silicon oxy-nitrides, are used for various semiconductor applications, such as embedded resistors in ReRAM cells. However, most common nitrogen containing precursors, such as molecular nitrogen and ammonia, require high deposition temperatures, such as at least about 700° C. or even at least about 1000° C. At low temperatures, the deposition rates are very slow and resulting nitrides have low nitrogen concentration resulting in poor electrical properties. For example, when tantalum nitride is deposited using ammonia at 150° C., the deposition rate is only 0.03 nanometers per ALD cycle and the density of the resulting structure is about 6.75 g/cm³. Yet, many substrates can only be processed at low temperatures because other temperature sensitive structures may be present on the same substrate. For example, TaN deposited at 360° C. using the same precursors (TBTDETa and NH₃) has film density of 9-10 g/cm³ (compared to 6.75 g/cm³ if deposited at low temp 150° C.). Furthermore, many ALD and CVD precursors, such as TDMAHf and TBTDET, require significantly lower substrate temperature than the minimum activation temperature of many of the nitride containing precursors and, as a result, these precursors were not used to form nitrides.

Provided are methods of forming nitrides at low substrate temperatures, such as less than 500° C., less than 400° C., or even less than 350° C. Instead of using conventional nitrogen containing precursors (e.g., molecular nitrogen and ammonia) that have high activation energies and, as a result, require high temperatures, precursors with low activation energies may be used. In some embodiments, these low activation energy precursors include one or more nitrogen-nitrogen single bonds and/or one or more nitrogen-nitrogen double bonds. Some examples of such nitrogen containing precursors include hydrazine (N₂H₄), diazene (N₂H₂), triazene (N₃H₃), triazane (N₃H₅), alkyl-substituted variations thereof, and salts thereof. For purposes of this document, nitrogen containing precursors may be also referred to as nitrogen containing reagents and include all materials that are introduced into chamber and react with another precursors (e.g., a metal containing precursor) to form a nitride layer (e.g., metal nitrides, metal silicon nitrides, metal oxy-nitrides and metal silicon oxy-nitrides). A table below illustrates substrate temperatures needed for deposition of silicon nitride using different nitrogen containing precursors.

TABLE

| Precursor | Temperature to Form SiN |
|---|---|
| Molecular nitrogen (N₂) | 900° C.-1000° C. |
| Ammonia (NH₃) | 700° C.-900° C. |
| Hydrazine (N₂H₄) | 400° C.-500° C. |
| Diazene (N₂H₂) | 150° C.-250° C. |
| Triazane (N₃H₅) | 150° C.-200° C. |

When the nitrogen containing precursors with lower reaction temperatures are used with the low-temperature chemical element containing precursors, the deposition rates and properties of the resulting nitrides are within a suitable range. For example, when hydrazine (N₂H₄) are used to deposit tantalum nitride at 150° C., the deposition rate is 0.065 nanometers per ALD cycle and the density of the resulting layer is about 8.25 g/cm³, which are substantially improved values in comparison with the ammonia example described above.

The nitrides can be formed using ALD, CVD, variations thereof (e.g., PECVD, MOCVD) and other like techniques. For example, an ALD technique may be used, in which a chemical element containing precursor is first introduced into a chamber containing a substrate at a temperature of less than 500° C. The chemical element containing precursors includes a chemical element that is not nitrogen. The chemical element may be a metal or, more specifically, a transition metal that later forms a nitride on the surface of the substrate. Because the substrate is kept at a low temperature, various temperature sensitive precursors may be used, such as TDMAHf and TBTDET. Some of the chemical element containing precursor may adsorb on the surface of the substrate. The remaining precursor may be removed from the chamber by purging. A low temperature nitrogen containing precursor may be then introduced into the chamber. Various examples of such precursors are presented above. The low temperature nitrogen containing precursor may react with the chemical element containing precursor (while the substrate is at the temperature of less than 500° C.) to form nitrides. For purposes of this disclosure, the low temperature nitrogen containing precursor is defined as a precursor that includes nitrogen and is operable to form nitrides at temperatures of less than 500° C.

Nitride and oxy-nitride layers formed using these methods may be used as embedded resistors of resistive switching memory ReRAM cells and other like applications. In some embodiments, oxy-nitride layers formed using these methods may be used resistive switching layers of resistive switching memory ReRAM cells. While this disclosure primarily focuses on ReRAM applications of these methods, it would be understood by one having ordinary skills in the art that other applications are also within the scope. For example, nitrides can be used as insulators, wide bandgap semiconductors, electrodes, diffusion barriers, and other applications.

Examples of ReRAM Cells and their Switching Mechanisms

A brief description of ReRAM cells is provided for better understanding of various features of nitride and oxy-nitride layers formed using low-temperature deposition techniques. A ReRAM cell includes a resistive switching layer formed from a dielectric material exhibiting resistive switching characteristics. A dielectric, which is normally insulating, can be made to conduct through one or more filaments or conduction paths formed after application of a sufficiently high voltage. The conduction path formation can arise from different mechanisms, including defects, metal migration, and other mechanisms further described below. Once the one or more filaments or conduction paths are formed in the dielectric component of a memory device, these filaments or conduction paths may be reset (or broken resulting in a high resistance) or set (or re-formed resulting in a lower resistance) by applying certain voltages.

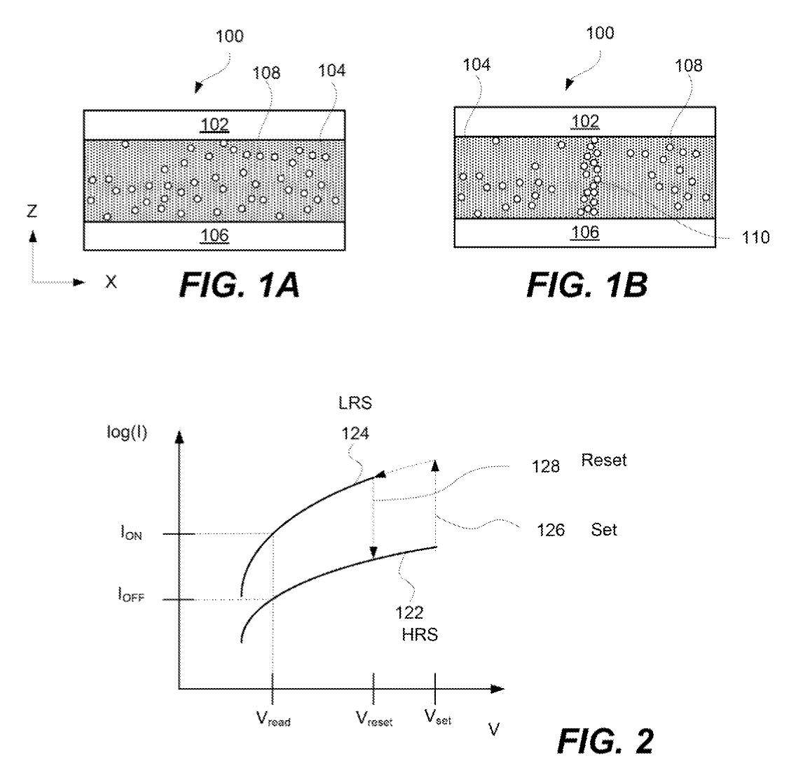

FIG. 1A illustrates a schematic representation of ReRAM cell 100 including top electrode 102, bottom electrode 106, and resistive switching layer 104 provided in between top electrode 102 and bottom electrode 106. It should be noted that the “top” and “bottom” references for electrodes 102 and 106 are used solely for differentiation and not to imply any particular spatial orientation of these electrodes. Often other references, such as “first formed” and “second formed” electrodes or simply “first” and “second”, may be used identify and distinguish the two electrodes. ReRAM cell 100 may also include other components, such as current limiting layers, diodes, and other components.

Resistive switching layer 104 may be initially formed from a dielectric material. It later can be made to conduct through one or more filaments or conduction paths formed by applying first a forming voltage (after initial fabrication) and later a set voltage (during operation). To provide this resistive switching functionality, resistive switching layer 104 includes a concentration of electrically active defects 108, which are sometimes referred to as traps. For example, some charge carriers may be absent from the layer (i.e., vacancies) and/or additional charge carriers may be present (i.e., interstitials) representing defects 108. In some embodiments, defects may be formed by impurities (i.e., substitutions). These defects may be utilized for ReRAM cells operating according to a valence change mechanism, which may occur in specific transition metal oxides and is triggered by a migration of anions, such as oxygen anions. Migrations of oxygen anions may be represented by the motion of the corresponding vacancies, i.e., oxygen vacancies. A subsequent change of the stoichiometry in the transition metal oxides leads to a redox reaction expressed by a valence change of the cation sub-lattice and a change in the electrical conductivity. In this example, the polarity of the pulse used to perform this change determines the direction of the change, i.e., reduction or oxidation. Other resistive switching mechanisms include bipolar electrochemical metallization mechanisms and thermochemical mechanisms, which leads to a change of the stoichiometry due to a current-induced increase of the temperature.

Without being restricted to any particular theory, it is believed that defects 108 can be reoriented within resistive switching layer 104 to form filaments or conduction paths as, for example, schematically shown in FIG. 1B as element 110. This reorientation of defects 108 occurs when a set voltage or a forming voltage is applied to electrodes 102 and 106. Sometimes, reorientation of defects 108 is referred to as “filling the traps” when a set voltage is applied (to form one or more filaments or conduction paths) and “emptying the traps” when a reset voltage is applied (to break the previously formed filaments or conduction paths).

Defects 108 can be introduced into resistive switching layer 104 during or after its fabrication. For example, a concentration of oxygen deficiencies can be introduced into metal oxides during their deposition or during subsequent annealing.

Operation of ReRAM cell 100 will now be briefly described with reference to FIG. 2 illustrating a logarithmic plot of a current passing through a unipolar ReRAM cell as a function of a voltage applied between the electrodes of the ReRAM cell, in accordance with some embodiments. Similar characteristics are demonstrated by bipolar cells, additional details of which are further presented below. ReRAM cell 100 may be either in a low resistive state (LRS) defined by line 124 or high resistive state (HRS) defined by line 122. Each of these resistive states is used to store a different logic state, e.g., HRS may be read as logic “one” and LRS may be read as logic “zero,” or vice versa. Therefore, each ReRAM cell that has two resistive states may be used to store one bit of data. It should be noted that some ReRAM cells may have three and even more resistive states allowing multi-bit storage in the same cell.

HRS and LRS correspond to the presence or absence of one or more filaments or conductive paths in resistive switching layer 104 and of connections between these filaments or conduction paths and the two electrodes 102 and 106. For example, a ReRAM cell may be initially fabricated in LRS and then switched to HRS, or vice versa. A ReRAM cell may be switched back and forth between LRS and HRS many times, defined by set and reset cycles. Furthermore, a ReRAM cell may maintain its LRS or HRS for a substantial period of time and withstand a number of read cycles.

The overall operation of ReRAM cell 100 may be divided into a read operation, set operation (i.e., turning the cell “ON”), and reset operation (i.e., turning the cell “OFF”). Set and reset operations may be referred to as write operations. During the read operation, the state of ReRAM cell 100 (more specifically, the resistive state of resistive switching layer 104) can be sensed by applying a sensing voltage to electrodes 102 and 106. The sensing voltage is sometimes referred to as a “READ” voltage and indicated as V_{READ} in FIG. 2. If ReRAM cell 100 is in HRS represented by line 122, the external read and write circuitry connected to electrodes 102 and 106 will sense the resulting “OFF” current (I_{OFF}) that flows through ReRAM cell 100. As stated above, this read operation may be performed multiple times without switching ReRAM cell 100 between HRS and LRS. In the above example, the ReRAM cell 100 should continue to output the “OFF” current (I_{OFF}) when the read voltage (V_{READ}) is applied to the electrodes.

Continuing with the above example, when it is desired to switch ReRAM cell 100 into a different logic state (corresponding to LRS), ReRAM cell 100 is switched from its HRS to LRS. This operation is referred to as a set operation. This may be accomplished by using the same read and write circuitry to apply a set voltage (V_{SET}) to electrodes 102 and 106. Applying the set voltage (V_{SET}) forms one or more filaments or conduction paths in resistive switching layer 104 and switches ReRAM cell 100 from its HRS to LRS as indicated by arrow 126. It should be noted that formation or breaking of filaments or conduction paths in resistive switching layer 104 may also involve forming or breaking electrical connections between these filaments and one (e.g., reactive electrode) or both electrodes. The factor is passage of the current between the two electrodes.

In LRS, the resistive characteristics of ReRAM cell 100 are represented by line 124. In this LRS, when the read voltage (V_{READ}) is applied between electrodes 102 and 106, the external read and write circuitry will sense the resulting “ON” current (I_{ON}) that flows through ReRAM cell 100. Again, this read operation may be performed multiple times without switching ReRAM cell 100 between LRS and HRS.

It may be desirable to switch ReRAM cell 100 into a different logic state again by switching ReRAM cell 100 from its LRS to HRS. This operation is referred to as a reset operation and should be distinguished from set operation during which ReRAM cell 100 is switched from its HRS to LRS. During the reset operation, a reset voltage (V_{RESET}) is applied to ReRAM cell 100 to break the previously formed filaments or conduction paths in resistive switching layer 104, switching ReRAM cell 100 from its LRS to HRS as indicated by arrow 128. Reading of ReRAM cell 100 in its HRS is described above.

Overall, ReRAM cell 100 may be switched back and forth between its LRS and HRS many times. Read operations may be performed in each of these states (between the switching operations) one or more times or not performed at all. It should be noted that application of set and reset voltages to change resistive states of the ReRAM cell involves complex mechanisms that are believed to involve localized resistive heating as well as mobility of defects impacted by both temperature and applied potential.

ReRAM cell 100 may be configured to have either unipolar switching or bipolar switching. The unipolar switching does not depend on the polarity of the set voltage (V_{SET}) and reset voltage (V_{RESET}) applied to the electrodes 102 and 106 and, as a result, to resistive switching layer 104. In the bipolar switching, the set voltage (V_{SET}) and reset voltage (V_{RESET}) applied to resistive switching layer 104 need to have different polarities.

In some embodiments, the set voltage (V_{SET}) is between about 100 mV and 10V or, in some embodiments, between about 500 mV and 5V. The length of set voltage pulses (t_{SET}) may be less than about 100 milliseconds, less than about 5 milliseconds, or even less than about 100 nanoseconds. The read voltage (V_{READ}) may be between about 0.1 and 0.5 of the write voltage (V_{SET}). In some embodiments, the read currents (I_{ON} and I_{OFF}) are greater than about 1 mA or, in some embodiments, greater than about 5 mA to allow for a fast detection of the state by reasonably small sense amplifiers. The length of read voltage pulse (t_{READ}) may be comparable to the length of the corresponding set voltage pulse (t_{SET}) or may be shorter than the write voltage pulse (t_{RESET}).

A ratio of set and reset currents (i.e., an I_{SET}/I_{RESET} ratio) that corresponds to a set voltage (V_{SET}) and reset voltage (V_{RESET}) may be at least about 5 or, in some embodiments, at least about 10 to make the state of ReRAM cell easier to determine. ReRAM cells should be able to cycle between LRS and HRS at least about 10³ times or, in some embodiments, at least about 10⁷ times without failure. A data retention time (t_{RET}) should be at least about 5 years or, in some embodiments, at least about 10 years at a thermal stress up to 85° C. and small electrical stress, such as a constant application of the read voltage (V_{READ}). Other considerations may include low current leakage, such as less than about 40 A/cm² measured at 0.5 V per 20 Å of oxide thickness in HRS.

In some embodiments, the same ReRAM cell may include two or more resistive switching layers interconnected in series. Pairs of resistive switching layers may directly contact each other, or they may be separated by one or more intermediate layers.

In some embodiments, a ReRAM cell is subjected to a forming operation, during which the initially insulating properties of the resistive switching layer are altered and the ReRAM cell is configured into the initial LRS or HRS. The forming operation may include a very short high discharge current peak associated with a forming voltage. The LRS level of the resistive switching layer for subsequent switching is determined by the filaments or connections created by the forming operation. If the forming operation makes the resistive-switching layer too conductive, the cell may be difficult to reset. In this case, a resistive switching layer with very low levels of resistance in the LRS may be limited in terms of scaling down. This difficulty may be resolved by positioning such resistive switching layers in series with other components providing additional resistance to the overall ReRAM cell.

### Processing Examples

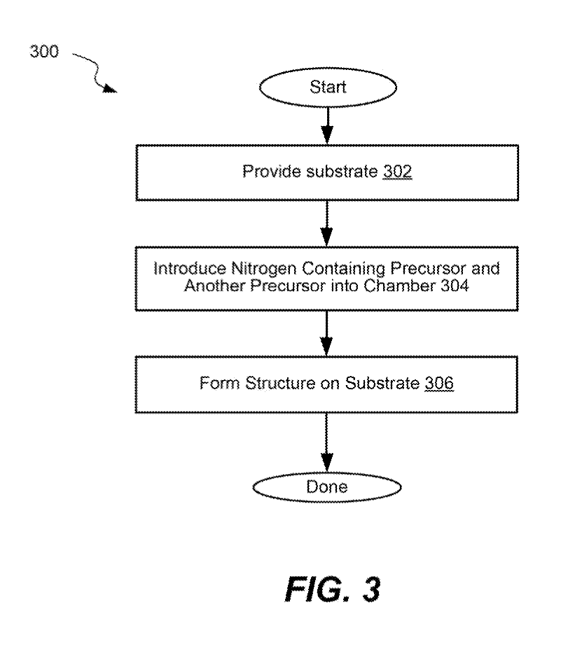

FIG. 3 illustrates a process flow chart corresponding to method 300 of fabricating a resistive random access memory cell, in accordance with some embodiments. Method 300 may commence with providing a substrate during operation 302. In some embodiments, the substrate may include a first electrode of a ReRAM cell as further described below. Alternatively, method 300 may proceed with forming a first electrode on the substrate. For example, a titanium nitride electrode may be formed using sputtering. Deposition of the titanium nitride electrode may be performed using a titanium target in a nitrogen atmosphere maintained at a pressure of between about 1-20 mTorr. The power density may be maintained at 3-11 W/cm² (150-500 Watts on a 3″ diameter target) that may result in a deposition rate of about 0.5-5 Angstroms per second (depending on the size of the target sample and other process parameters). Some of the provided process parameters are for illustrative purposes only and generally depend on deposited materials, tools, deposition rates, and other factors.

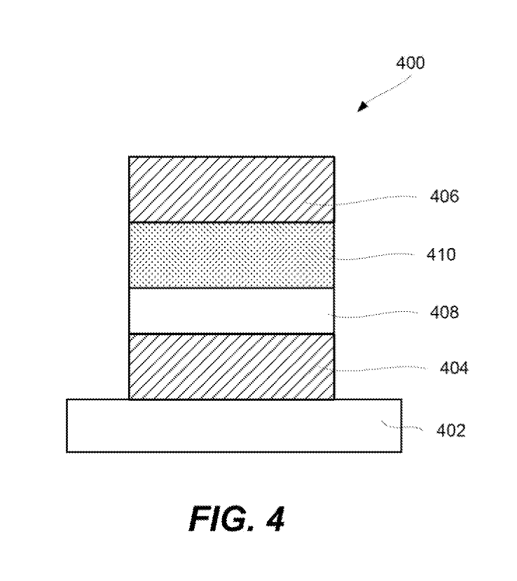

The substrate provided during operation 302 may be at a temperature of less than 500° C. In some embodiments, the temperature of the substrate is less than 400° C. or even less than 350° C. The substrate may include a surface for forming a nitride layer during operation 306. This surface may be a surface of the first electrode or the surface of a resistive switching layer as further described below with reference to FIG. 4.

Method 300 may then proceed by introducing a nitrogen containing precursor and a chemical element containing precursor into the chamber during operation 304. The nitrogen containing precursor includes nitrogen and is configured to react with the chemical element containing precursor at a temperature of less than 500° C. or, more specifically, at less than 400° C. or even at less than 350° C. Some examples of suitable nitrogen containing precursors include hydrazine (N₂H₄), diazene (N₂H₂), triazene (N₃H₃), triazane (N₃H₅), alkyl-substituted variations thereof, or salts thereof. In general, the longer the nitrogen chain of the component, the more easily it breaks and more reactive the component. In some embodiments, a nitrogen containing precursor used during operation 304 includes molecules, each having at least two nitrogen atoms or even at least three nitrogen atoms. These multiple nitrogen atoms may be bonded to each other using a single bond (e.g., hydrazine (N₂H₄) and triazane (N₃H₅)) or a double bond (e.g., (N₂H₂) and triazene (N₃H₃)). In some embodiments, the nitrogen containing precursor introduced into the chamber during operation 304 is hydrazine (N₂H₄). Alternatively, the nitrogen containing precursor introduced into the chamber during operation 304 may be triazane (N₃H₅).

The chemical element containing precursor introduced into the chamber during operation 304 includes a chemical element other than nitrogen. Examples of chemical element containing precursors include TDMAHf, TBTDET, TEMAHf, TDEAHf, ZyALD, 3DMAS, SAM24, and PDMATa. Overall, the chemical element may be tantalum, silicon, hathium, or zirconium. In some embodiments, the chemical element includes a transition metal. In some embodiments, the chemical element containing precursor includes both a transition metal and silicon. Alternatively, operation 304 may involve introducing two different chemical element containing precursors into the chamber in addition to the nitrogen containing precursor. One of these chemical element containing precursors may include silicon, while another one may include tantalum, hafnium, or zirconium. In some embodiments, operation 304 may also involve introducing an oxygen containing precursor to form oxy-nitride.

In some embodiments, method 300 may involve a CVD technique, in which case the chemical element containing precursor and the nitrogen containing precursor may be added at the same time. The flow rates of these two precursors (and other precursors, if used), the temperature of the substrate, and other process parameters may be varied to control the properties of the resulting layers during operation 306. Operations 304 and 306 may be performed substantially concurrently such that the nitride layer may start forming soon after the chemical element containing precursor and the nitrogen containing precursor are introduced into the chamber and continue forming while the chemical element containing precursor and the nitrogen containing precursor continue being introduced into the chamber.

Alternatively, method 300 may involve an ALD technique, in which case the chemical element containing precursor may be first introduced into the chamber and allowed to adsorb on the surface of the substrate. The remaining chemical element containing precursor may be purged from the chamber before the nitrogen containing precursor is introduced. When the nitrogen containing precursor is introduced into the chamber, it reacts with the chemical element containing precursor adsorbed on the surface and form a nitride layer during operation 306.

Overall, method 300 proceeds with operation 306 during which a nitride layer is formed when the chemical element containing precursor reacts with the nitrogen containing precursor and other precursors, if the other precursors are used. In some embodiments, forming the layer involves exposing the surface of the substrate to UV radiation. The UV radiation may at least partially dissociate some of the nitrogen containing precursor. Dissociation of the nitrogen containing precursor promotes its reaction with the chemical element containing precursor(s) so that the substrate temperature may be further reduced without impact to the deposition rates and other parameters. In some embodiments, forming the layer is performed without using plasma; in other words, the CVD and ALD operations are not plasma-enhanced.

In some embodiments, method 300 may involve using an ALD technique to form a hafnium nitride layer. Method 300 may commence with providing a substrate into a chamber during operation 302. The substrate may at the temperature of less than 500° C. Method 300 follows by introducing TDMAHf into the chamber and forming a monolayer of TDMAHf on the surface of the substrate and the introducing hydrazine into the chamber during operation 304. It should be noted that during ALD, hydrazine is introduced into the chamber after the monolayer of TDMAHf is formed on the surface. Method 300 may proceed with forming a layer including hafnium and nitride on the surface. The layer is formed when hydrazine reacts with TDMAHf.

Overall, each ALD cycle involves the following four steps: introducing one or more chemical element containing precursors into the chamber to form an adsorbed layer, followed by purging the unadsorbed precursor and any superfluous by-products from the chamber, and then introducing nitrogen containing precursors that will react with the adsorbed layer to form a portion of or the entire nitride layer, followed by purging the unreacted nitrogen containing precursors and any superfluous by-products from the chamber. A layer formed during each atomic layer deposition cycle described above may be between about 0.25 and 2 Angstroms (0.025-0.2 nm) thick, averaged over the area of the layer. The cycle may be repeated multiple times until the overall layers reaches it desired thickness. In some embodiments, ALD cycles are repeated using different precursors.

### Examples of ReRAM Cells Having Nitrogen Containing Embedded Resistors

FIG. 4 is a schematic illustration of ReRAM cell 400, in accordance with some embodiments. ReRAM cell 400 may be disposed on substrate 402 that may include other ReRAM cells, layers, or layers. ReRAM cell 400 includes first electrode 404 and second electrode 406. In some embodiments, first electrode 404 and/or second electrode 406 extend laterally to connect to other ReRAM cells, for example, in a cross-bar arrangement. ReRAM cell 400 also includes resistive switching layer 408. Resistive switching layer 408 is disposed between first electrode 404 and second electrode 406. ReRAM cell 400 also includes an embedded resistor 410, which is disposed in the same stack with resistive switching layer 408 and which is connected in series with resistive switching layer 408.

Electrodes 404 and 406 provide electronic communication to resistive switching layer 308 of ReRAM cell 400. One or both electrodes may directly interface resistive switching layer 408 or be separated from it by other layers, such as barrier layers, current limiting layers, and the like. Depending on the materials used for electrode construction, the electrode (e.g., an electrode formed from titanium nitride) itself may also serve as an adhesion layer and/or barrier layer. In certain embodiments, one or both electrodes are also function as signal lines (i.e., bit and/or word lines) and are shared by other ReRAM cells.

Some examples of electrode materials include silicon (e.g., n-doped poly-silicon and p-doped poly-silicon), silicides, silicide-germanides, germanides, titanium, titanium nitride (TiN), platinum, iridium, iridium oxide, ruthenium, ruthenium oxide, and the like. Generally, any sufficiently conductive material may be used to form an electrode. In some embodiments, barrier layers, adhesion layers, antireflection coatings and/or the like may be used with the electrodes and to improve device performance and/or aid in device fabrication.

In some embodiments, one electrode may be a higher work function material, and the other electrode may be a lower work function material than resistive switching layer. For example, a noble or near noble metal (i.e., a metal with a low absolute value free energy change (|ΔG|) of oxide formation) may be used for one electrode. Specific examples include iridium, iridium oxide, platinum, ruthenium, and ruthenium oxide. The other electrode may be a lower work function material, such as titanium nitride. In these embodiments, the reset pulse at the electrode having the higher work function may be a positive pulse.

In some embodiments, one or both electrodes may be multi-layer electrodes formed by one or more different materials. For example, an electrode can include a base layer and capping layer. The base layer may include ruthenium, ruthenium oxide, iridium, iridium oxide, platinum, and various combinations thereof. The capping layer may include tungsten, tungsten carbonitride, and/or tungsten carbon. The multi-layer electrodes can be used to improve adhesion properties and performance of memory elements in some configurations and embodiments.

Resistive switching layer 408 can be fabricated from a dielectric material, such as a metal oxide material or other similar material that can be switched between two or more stable resistive states. In some embodiments, resistive switching layer 306 is fabricated from a high bandgap material, e.g., a material that has a bandgap of at least about 4 electron Volts. Some examples of such materials include hafnium oxide (HfₓO_{y}), tantalum oxide (TaₓO_{y}), aluminum oxide (AlₓO_{y}), lanthanum oxide (LaₓO_{y}), yttrium oxide (YₓO_{y}), dysprosium oxide (DyₓO_{y}), ytterbium oxide (YbₓO_{y}) and zirconium oxide (ZrₓO_{y}). The high bandgap materials may improve data retention in ReRAM cell 300 and reduce the current leakage since the amount of trapped charge in these materials is less than a lower bandgap material. Furthermore, the high bandgap materials create a large barrier height that the carriers have to cross during the read, set, and reset operations. Other suitable materials for resistive switching layer 306 include titanium oxide (TiOₓ), nickel oxide (NiOₓ), and cerium oxide (CeOₓ). Furthermore, semi-conductive metal oxide (p-type or n-type), such as zinc oxides (ZnₓO_{y}), copper oxides (CuₓO_{y}), and their nonstoichiometric and doped variants can be used for resistive switching layer 408.

In some embodiments, resistive switching layer 408 includes a dopant that has an affinity for oxygen, such as various transition metals (e.g., aluminum, titanium, and zirconium), to form a metal-rich resistive switching layer, such as a non-stoichiometric oxide (e.g., HfO_{1.5}-HfO_{1.9} or, more specifically, HfO_{1.7}). The dopant may be the same material as a metal of the base oxide (e.g., HfO₂ doped with hafnium) or different (e.g., HfO₂ doped with aluminum, titanium, and zirconium). Oxygen deficiency of the metal-rich resistive switching layer corresponds to a number of oxygen vacancies, which are believed to be defects responsible for resistive switching. The amount of defects is controlled to achieve certain switching and forming voltages, operating currents, improve performance consistency and data retention.

Resistive switching layer 408 may have a thickness of between about 10 Angstroms to about 1000 Angstroms, such as between about 20 Angstroms and 200 Angstroms or, more specifically, between about 50 Angstroms and 100 Angstroms. Thinner resistive switching layers may be deposited using ALD, while thicker resistive switching layers may be deposited using may be deposited using ALD as well as physical vapor deposition (PVD) and, in some embodiments, chemical vapor deposition (CVD).

Embedded resistor 410 may be fabricated from a nitride or more specifically from a metal nitride. Some examples include metal nitride films (e.g., TaN, HfN, TiN, ZrN, TaN), metal silicon nitride films (e.g., TaSiN, HfSiN, TiSiN, ZrSiN, TaSiN), or oxynitride counterpart thereof (e.g., TaON, HfON, TiON, ZrON, TaSiON, TaSiON, HfSiON, TiSiON, ZrSiON, TaSiON). In some embodiments, embedded resistor 410 may include metal silicon nitrides, metal aluminum nitrides, or metal boron nitrides, such as tantalum silicon nitride, tantalum aluminum nitride, tantalum boron nitride, titanium silicon nitride, titanium aluminum nitride, titanium boron nitride, tungsten silicon nitride, tungsten aluminum nitride, tungsten boron nitride, molybdenum silicon nitride, molybdenum aluminum nitride, and molybdenum boron nitride. In some embodiments, the embedded resistor is formed from tantalum silicon nitride. The atomic ratio of tantalum to silicon in the embedded resistor may be between 2 and 20. Without being restricted to any particular theory, it is believed that tantalum silicon nitride can be tuned for initial electrical breakdown to yield am embedded resistor with desirable characteristics.

Incorporation of silicon, aluminum, boron and/or nitrogen into embedded resistor 410 tends to increase its resistivity, while the base metal (e.g., tantalum, titanium, tungsten, molybdenum) helps to maintain its stable resistivity and high breakdown voltage characteristics especially after the initial breakdown. Furthermore, these metal silicon nitrides, metal aluminum nitrides, and metal boron nitrides tend to be stable when subjected to processing temperatures, such as at least about 750° C. for 60 seconds used for diode activation. In some embodiments, embedded resistor 310 retains its characteristics when subjected to a temperature of between about 500° C. to 1000° C. for about 10 seconds to 10 minutes, which may be used, for example, to activate diodes provided on the same substrate. Addition of silicon, aluminum, and/or boron into metal nitrides improves their thermal stability and helps to withstand crystallization (and remaining in their amorphous states).

In some embodiments, embedded resistor 410 has a thickness of between about 10 Angstroms and 200 Angstroms or, more specifically, between about 20 Angstroms and 100 Angstroms thick. The footprint (i.e., cross-sectional area) of embedded resistor 410 may be between about 20 nanometers-square and 100 nanometers-square or, more specifically, between about 30 nanometers-square and 60 nanometers-square, such as about 60 nanometers-square.

Some ReRAM cells include intervening layers between embedded resistor 410 and resistive-switching layer 408; for example, intermediate electrodes, barrier layers, passivation layers, doping layers, oxygen-gettering layers, buffer layers, and various interfacial layers. Some ReRAM cells have composition gradients in embedded resistor 410 or resistive-switching layer 408. Some ReRAM cells may have embedded resistor 410 below resistive-switching layer 408. Some embedded resistors 410 may also function as electrodes (e.g., electrode 406).

### Apparatus Examples

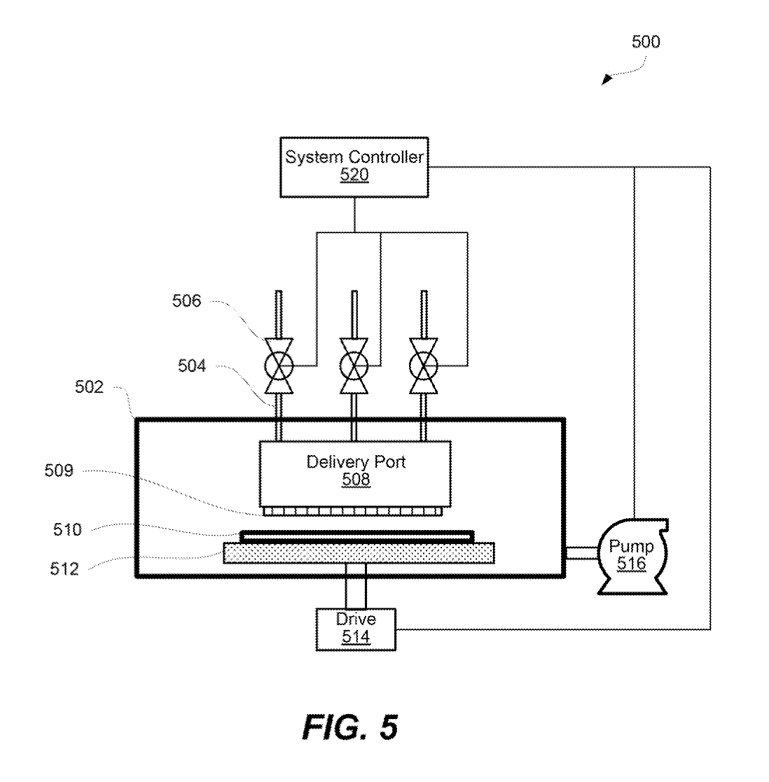

FIG. 5 illustrates a schematic representation of atomic layer deposition apparatus 500 for fabricating nitride layers at low temperatures, in accordance with some embodiments. For clarity, some components of apparatus 500 are not included in this figure, such as a wafer-loading port, wafer lift pins, and electrical feed-throughs. Apparatus 500 includes chamber 502 connected to processing gas delivery lines 504. While FIG. 5 illustrates three delivery lines 504, any number of delivery lines may be used. Each line may be equipped with a valve and/or mass flow controller 506 for controlling the delivery rates of processing gases into chamber 502. In some embodiments, gases are provided into delivery port 508 prior to exposing substrate 510 to processing gases. Delivery port 508 may be used for premixing gases (e.g., precursors and diluents) and evenly distributing the gases over the surface of substrate 510. Delivery port 508 is sometimes referred to as a showerhead. Delivery port 508 may include a diffusion plate 509 having with multiple holes for gas distribution.

Chamber 502 encloses substrate support 512 for holding substrate 510 during its processing. Substrate support 512 may be made from a thermally conducting metal (e.g., W, Mo, Al, Ni) or other like materials (e.g., a conductive ceramic) and may be used to maintain the substrate temperature at desired levels. Substrate support 512 may be connected to drive 514 for moving substrate 510 during loading, unloading, process set-up, and sometimes even during processing. Chamber 502 may be connected to vacuum pump 516 for evacuating reaction products and unreacted gases from chamber 502 and for maintaining the desirable pressure inside chamber 502.

Apparatus 500 may include system controller 520 for controlling process conditions during electrode and resistive switching layer deposition and other processes. Controller 520 may include one or more memory devices and one or more processors with a CPU or computer, analog and/or digital input/output connections, stepper motor controller boards, etc. In some embodiments, controller 520 executes system control software including sets of instructions for controlling timing, gas flows, chamber pressure, chamber temperature, substrate temperature, RF power levels (if RF components are used, e.g., for process gas dissociation), and other parameters. Other computer programs and instruction stored on memory devices associated with controller may be employed in some embodiments.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

What is claimed is:

1. A method comprising:
providing a substrate in a chamber;
introducing a first precursor and a second precursor into the chamber,
wherein the first precursor comprises nitrogen, and
wherein the second precursor comprises a chemical element other than nitrogen; and
forming a layer on a surface of the substrate,
wherein forming comprises chemically reacting the first precursor and the second precursor,
wherein the layer comprises nitrogen and the chemical element; and
wherein the substrate is maintained at a temperature of less than 500° C. while the layer is being formed and the first precursor and the second precursor chemically react.

2. The method of claim 1, wherein the substrate is maintained at a temperature of less than 400° C. while the layer is being formed and the first precursor and the second precursor chemically react.

3. The method of claim 1, wherein the substrate is maintained at a temperature of less than 350° C. while the layer is being formed and the first precursor and the second precursor chemically react.

4. The method of claim 1, wherein the first precursor comprises one of hydrazine (N₂H₄), diazene (N₂H₂), triazene (N₃H₃), triazane (N₃H₅), alkyl-substituted variations thereof, or salts thereof.

5. The method of claim 1, wherein the first precursor comprises hydrazine (N₂H₄).

6. The method of claim 1, wherein the first precursor comprises triazane (N₃H₅).

7. The method of claim 1, wherein the chemical element comprises one of tantalum, silicon, hafnium, or zirconium.

8. The method of claim 1, wherein the chemical element comprises a transition metal.

9. The method of claim 1, wherein the layer further comprises silicon.

10. The method of claim 9, wherein the chemical element comprises one of tantalum, hafnium, or zirconium.

11. The method of claim 10, wherein the layer further comprises oxygen.

12. The method of claim 1, wherein the chemical element containing precursor comprises one of Tetrakis(DiMethylAmino)Hafnium or TertiaryButylimido-Tris(DiEthylamino)Tantalum.

13. The method of claim 1, wherein forming the layer comprises using atomic layer deposition (ALD).

14. The method of claim 1, wherein forming the layer comprises using chemical vapor deposition (CVD).

15. The method of claim 1, wherein forming the layer comprises exposing the surface of the substrate to ultraviolet (UV) radiation.

16. The method of claim 1, wherein forming the layer is performed without using plasma.

17. The method of claim 1, wherein the layer is an embedded resistor of a resistive random access memory (ReRAM) cell.

18. The method of claim 17, further comprising forming a resistive switching layer on the substrate.

19. The method of claim 1, wherein a deposition rate during forming of the layer is between about 0.005 nanometers per minute and 0.05 nanometers per minute.

20. A method comprising:
providing a substrate in a chamber,
introducing Tetrakis(DiMethylAmino)Hafnium into the chamber;
forming a monolayer of Tetrakis(DiMethylAmino)Hafnium on a surface of the substrate;
introducing hydrazine into the chamber; and
forming a layer comprising hafnium and nitrogen on the surface,
wherein the layer is formed when hydrazine reacts with Tetrakis(DiMethylAmino)Hafnium in the monolayer at a substrate temperature less than 500° C.
